(19) United States
(12) Patent Application Publication
(10) Pub. No.: US 2011/0223889 A1
(43) Pub. Date: Sep. 15, 2011

(54) REAL-TIME, ABBREVIATED PERSONALLY-DESCRIPTIVE INDICATORS

(76) Inventors: Chastity Stephen, Toledo, OH (US); Jessica Shank, Toledo, OH (US); Abigail Shank, Toledo, OH (US)

(21) Appl. No.: 12/883,111

(22) Filed: Sep. 15, 2010

Related U.S. Application Data
(60) Provisional application No. 61/242,531, filed on Sep. 15, 2009.

(51) Int. Cl. H04W 4/20

(52) U.S. Cl. 455/414.1

(57) ABSTRACT

The present invention provides a downloadable application which can be used with existing platforms or operating systems to enable the sending of messages which have, in addition to text, associated pictorial information corresponding to emotional states and other ancillary information about the sender. The application associates a sender-chosen pictorial personally discriptive indicator with identifying information, such as the sender's name, and transmits it to an intended recipient, and enables the sender to update the pictorial personally discriptive indicator to give a real-time meter of emotional states of the sender and other ancillary information to the recipient.

### REFERENCE TO RELATED APPLICATION

This application claims the benefit of U.S. Provisional Application Ser. No. 61/242,531, filed Sep. 15, 2009, which is hereby incorporated by reference.

### BACKGROUND OF THE INVENTION

Texting and other forms of instant written communication can communicate specific facts about the sender. However, while the text sender may use written expression to communicate factually with a recipient, the message does not necessarily reveal contextual details pertaining to the sender, such as where the sender has returned from, or where the sender is, or information about the sender's emotional state, such as anger, sadness, and the like. However, the revelation of such contextual details could give additional dimension to a written message, potentially making it more valuable to the recipient with respect to ascertaining the meaning of the written message. In such cases, in order to ascertain such ‘ancillary information,” the recipient must essentially deduce it from the message as it is being read. Thus some of the words of the message are actually read without any awareness on the part of the reader of meaningful ambient detail. When a sender does send a message containing such emotional or contextual information, the recipient must take the time to read the message before appreciating the full scope of the communication. Furthermore, while a sender can theoretically articulate subtle emotions in a written message, it is often difficult or beyond the expressive capability or linguistic grasp of the sender to meaningfully embody and express emotions in a written conversation.

A mechanism for the transmission of ancillary information such as emotional or other contextual information would be a welcome addition to the standard means of informing a recipient via messages composed of text.

### SUMMARY OF THE INVENTION

The present invention provides a means for transmitting such ancillary information by providing a downloadable application which can either be used with existing platforms such as, for example, the ANDROID, PALM, iOS or BLACKBERRY platforms, or operating systems such as, for example, MACINTOSH or WINDOWS. Preferably, it is used with the ANDROID cellular telephone platform. In other embodiments, the functional software can be integrated into an existing platform, such as, for example, the ANDROID phone platform. In further embodiments, the hardware is adapted to accommodate the application, which has been integrated into the platform. The accommodation can comprise a button by which a sender can accomplish the task of associating ancillary information with identifying information, such as the sender's name, such that others who have downloaded or otherwise have the software present on their communication device and who receive messages from the sender, and/or those who maintain the sender in their list of contacts can have access to the sender's ancillary information.

Preferably, the ancillary information, or personally descriptive information, is accessed by displaying a corresponding “Personally Descriptive Indicator” with the sender's identifying information, such as, for example, the sender's name. Those who can access the sender's ancillary information are referred to herein as “recipients.”

### DETAILED DESCRIPTION OF THE INVENTION

The present invention creates ease in conversation. It lessens confusion and guessing associated with modes of communication such as texts, e-mails and phone calls. The system allows the communication of select personal information by the attachment of a diagram or phrase, uniquely corresponding to an emotional state or other personal descriptor, such as physical condition, spiritual condition, actions or tasks one is taking, planning to take or one has taken, preferably in the recent past. For example the indicator can inform the recipient that the sender is injured, leaving a store, school, the library, working or playing on the computer, and the like.

The present invention provides a means for transmitting such ancillary information such as, for example, temporal contextual information about the sender (where the sender is, has been or is planning to go), emotional disposition information about the sender (a mood or emotional state), or other types of contextual information. The information can be transmitted prior to or simultaneously with the viewing of the message. In one embodiment is provided: A system comprising: i) a sending device associated with a sending user, the sending device including an installed operating system and an application; and ii) a receiving device associated with a receiving; wherein the application comprises computer-readable instructions recorded on a computer-readable medium, the instructions comprising instructions to: 1) associate input pictorial, Personally Descriptive Indicator (PDI) corresponding to the sending user with identifying information corresponding to the sending user, thereby creating an associated PDI; 2) transmit the associated PDI to the receiving device, such that the associated PDI can be accessed by the receiving user and displayed by the receiving device; and 3) replace the associated PDI with new PDI to generate a new associated PDI, such that the new associated PDI can be accessed by the receiving user and displayed by the receiving device. In another embodiment, the present invention comprises a method for transmitting ancillary information from a sending device operated by a sending user to a receiving device operated by a receiving user, said method comprising the steps of:

A) the sending user inputting pictorial, Personally Descriptive Indicator corresponding to the sender into a sending device, wherein said sending device comprises an operating platform and an application; wherein the application imparts to the sending device the ability to: 1) associate input pictorial, Personally Descriptive Indicator (PDI) corresponding to the sending user with identifying information corresponding to the sending user, thereby creating an associated PDI; 2) transmit the associated PDI fo the receiving device, such that the associated PDI can be accessed by the receiving user and displayed by the receiving device; and 3) replace the associated PDI with new PDI to generate a new associated PDI, such that the new associated PDI can be accessed by the receiving user and displayed by the receiving device; wherein the sending device carries out steps 1) and 2); and

B) the receiving user accessing the associated PDI and displaying it on the receiving device.

A “Personally Descriptive Indicator” is a pictorial representation which is representative of conditions or states which correspond to an individual, such as, for example, an emotional, physical, or spiritual state or condition. In other embodiments, the Personally Descriptive Indicator is descriptive of actions or tasks one has taken, is presently taking, or is planning to take. For example, the indicator can convey to the recipient that the sender is going to the grocery store, the mall, going clothes shopping, out to dinner, to a movie, going to get a cup of coffee, meet a friend, and the like. In other embodiments, the Personally Descriptive Indicator can convey that the sender has recently returned from someplace or was recently involved in a particular activity. For example, the Personally Descriptive Indicator can convey that the sender just returned from church, the office, the gym, or just finished working out, studying, praying, and the like. In other embodiments, the indicator can convey that the sender is about to undertake an activity or about to go somewhere. Examples of such include eating or fixing dinner or other meal, doing homework, going on vacation, going to the pool, going to the office, going to church, and the like.

The Personally Descriptive Indicator can be a pictorially descriptive representation, such as, for example, the depiction of a table with a checkered tablecloth to convey the idea of going out to a restaurant for dinner. Another example is the depiction of a simplified profile of an automobile to convey that the sender is going for a drive. The Personally Descriptive Indicator can be a symbolic representation. For example, a religious symbol, such as, for example, a cross or a depiction of a scroll, can convey that the sender is attending a Christian church service or synagogue, respectively. A depiction of a book can be used to convey that the sender is at the library. Other depictions which are less descriptive and more representational can be used, such as, for example, the use of depictions which are heavily stylized or the use of representations which are mostly or purely symbolic, such as, for example, the use of a triangle to indirectly represent a Christian church through reference to the trinity, a Christian doctrine.

If desired the indicator can be or can include a block of text, stylized as desired, preferably in addition to or as part of an image file. The indicator is preferably one or more image files, and while it can be descriptive text, the indicator is preferably primarily pictorial in nature. The indicator can be a small block of descriptive or symbolic text, stylized, if desired, or other. In general, the indicator can be a picture, symbol, diagram, anagram, modified or stylized text or lettering or other form of pictorial or visually-condensed information which is intended to convey to the recipient (or other viewer) information about the sender.

“Application” as used herein refers to software which is necessary to accomplish the selection of a Personally Descriptive Indicator and associate it with the sender via the sender's name or other identifying information. In some embodiments such software may also include that which enables a communication device to send and receive Personally Descriptive Indicators in association with sender-identifying information (the resulting association which is referred to herein as an “associated Personally Descriptive Indicator”). In further embodiments, software may further enable the communication device to update the associated Personally Descriptive Indicator at the behest of the sender. In some embodiments described herein, such as that involving a list of contacts, the software permits the updating of a sender's Personally Descriptive Indicator to generate a new associated Personally Descriptive Indicator, and allows the transmission and receipt of the updated Personally Descriptive Indicator.

The software may be a “downloadable” application in that it operates in conjunction with a platform or operating system, but is not part of the platform or operating system. Alternatively, the software may be part of the operating system or platform in that it is integrated into the operating system or platform. In such cases, it may be desirable to design the hardware receiving device such that it can facilitate the use of the application. For example, the placement of at least one button on the hardware which is exclusively for the use of the Personally Descriptive Indicator application is contemplated.

In the embodiments listed herein, it is contemplated that the choosing of a Personally Descriptive Indicator, the creation an associated Personally Descriptive Indicator, and, optionally, other aspects of application use, such as sending the associated Personally Descriptive Indicator to a contact, will be controlled through the use of menus or other known methods which allow the user to interact with the sending device and direct its function.

The “sending device” is the device which creates and sends the associated Personally Descriptive Indicator. The “receiving device” is the device to which the associated Personally Descriptive Indicator is sent. In a preferred embodiment, both are cellular telephones utilizing the ANDROID platform. In other embodiments, one or both are other communication devices, such as a laptop computer, a BLACKBERRY, a PALM PILOT or the like.

“Ancillary information” as used herein is the contextual information as described above which is conveyed by the use of a Personally Descriptive Indicator.

By “associated” it is meant that the nominal descriptor (corresponding to the sender) and the Personally Descriptive Indicator mutually correspond as can be ascertained by the recipient.

Herein, the term “sender” and “receiver” are synonymous with “sending user” and “receiving user,” respectively

In one embodiment, the abbreviated, Personally Descriptive Indicator is present in, attached to or associated with written communications such as text messages. In another embodiment, the indicator is attached to or associated with the senders name or other identifying information such that the message recipient will associate the indicator with identifying information, even if no message is received at the time. For example, the indicator may be next to or associated with the senders identifying information as it is displayed on the recipient's caller identification. In a further embodiment, the indicator is contained in an auditory announcement associated with the call.

In other embodiments, the indicator is only sent to those whose names are on the sender's contact list and who also have the sender on their own contact list. In yet another embodiment, the indicator is only received by those who have the sender on their own contact list. In still another embodiment, the recipient is in an arrangement with the sender such that the recipient subscribes or otherwise indicates or has indicated a willingness to receive periodic updates to the indicator information corresponding to a sender, and the sender periodically, such as for example, with a regular period, such as, for example, every two weeks, updates the indicator information, such that the recipients contact list is updated, with respect to the sender. Thus, the indicator can be announced to recipients identified in a database, such as a list of contacts associated with the device used for communicating the written communication. In other embodiments, the indicator can be selectively masked, such that recipients who otherwise would receive the indicator are temporarily suspended from receipt. For example, a university student who has spent the night bar-hopping may not want his or her parents to receive the “tipsy” indicator sent to friends.

The indicator system can include notification features such as the activation of a buzz or other auditory or visual indicator that a sender's indicator has changed. For example, in one embodiment, the changing of an indicator results in the sending of a signal to one or more contacts. Upon receipt of the signal, the contact's cell phone or other communication device gives an auditory signal, such as a buzz or a musical phrase; or a visual signal, such as a flash, to denote a change in indicator.

The indicator can also undergo programmed change, such as by changing to give information about the sender's schedule. In one embodiment, the indicator displays information relating to the present activities of the sender. In other embodiments, the indicator can additionally indicate activity duration, past or future activities, and other information related to the sender's schedule.

The indicator can also serve a matching function among recipients and senders. For example, a sender can use the indicator to inform recipients that they are looking for a partner for shopping, exercise, dinner, video game activities or the like. In some embodiments, the indicator can be completable, with a fully completed indicator displayed by some or all of the sender and/or recipients upon acceptance by one or more recipients.

In other embodiments, the indicator can comprise a time stamp which gives the recipient information with regard to the length of time a given indicator has applied, or the length of time until it does not apply. For instance, an angry indicator may comprise information that the sender has been angry for six hours. An indicator which informs the recipient that the sender is shopping also comprises information that the sender will be done or expects to be done in half an hour.

In another embodiment of the present invention, the indicator can be a personalized picture of the sender reflecting the sender's mood, activity or the like. The indicator can include other symbols or text.

The indicator can also be at the whim of the communication device, such as a cellular telephone. In this embodiment the device chooses the indicator, and optionally, the length of time it is displayed before it is changed.

As indicated above, in one embodiment, the indicator is “embedded” in the platform or operating system of the communication device, and operation of the application is directed by the use of a button on the communication device, such as on a numerical pad, under a menu or on a touch screen of a cell phone or other device capable of sending and receiving written communications as a selectable option. In another embodiment, the descriptor can be attached by activating a button which is, optionally clearly indicated.

The available indicators, can be, for example, text, diagrams, or both or mixtures of both. The indicators can be in color, such as colored text or diagrammatic indicators. In one embodiment, diagrammatic indicators are “emoticons.” The chosen one or more indicators correspond to the communication device, and the indicator can be attached, selectively, if desired, to outgoing text messages as well as caller identification indicators.

In one embodiment, the descriptive indicator application is available as a downloadable package of software which can be configured for use with an existing operating system or platform such as the I-PHONE platform, the ANDROID platform, or others which inform the function of cell phones, I-PHONEs, BLACKBERRYs, and other telecommunications devices. In a preferred embodiment, the descriptive indicator application is configured to platform is the ANDROID platform.

In one embodiment, the indicators are a standard part of the operating system on all phones, or those manufactured or sold by a given manufacturer or seller. In one embodiment, a consumer pays a fee. Optionally, the indicator can be installed or downloaded to communication devices such as, for example, cell phones, email, etc., at will. In one embodiment, the indicators are available for consumers with a given carrier, or on phones of a given type.

In one embodiment, the indicator expresses an emotion, such as, for example, anger or jealousy and the sender can choose from a finite list of emotions. See TABLE I. In one embodiment, an indicator setting is global and is attached to all communications from the sender. In another embodiment, the seller has the latitude to select emotions appropriate to a particular receiver (I am angry at you; I am in love with you, and the like).

TABLE II lists exemplary uses of the Personally Descriptive Indicator application in conjunction with an embodiment employing a cellular telephone in which the hardware incorporates a feature, such as a button, which facilitates the operation of the application.

### Example 1

In the sender's phone contact list the indicator is updated in real time and the phone has internet access, and the indicator is updated every time the sender uses his/her phone, enabling people to keep in touch on a level not experienced before.
Amber B. [Sad]
Jackson S. [Drunk]
Kurt H. [Determined]

### Example 2

Applications of the Personally Descriptive Indicator with respect to the operation of texting between two cellular telephones, both of which have the Personally Descriptive Indicator software downloaded:

1) A message is received by a recipient on a receiving cellular telephone. The message is sent by a sender from the sender's cellular telephone. Both the sender and the recipient have downloaded the Personally Descriptive Indicators software onto their phones. The message indicator on the receiving phone displays the text “Sis [pumped]” upon receipt of the message, indicating that the message is from the person identified as “Sis” in the recipient's contact list, and she is “pumped.” The sender has selected the Personally Descriptive Indicator function from a list and set it to the indicator “pumped” prior to sending the message and has not changed it, or the person has selected the indicator from a list and attached it to the message. Upon selecting “view now” the following appears: “From: Sis [pumped] Hey can you pick up some milk for mom?”

2) A message is received in the recipient's cellular telephone message Inbox, and he responds. The resulting text in the inbox appears as follows:
Jon [Tired]
What are you up to?
Dad [Rushed]
I′m here hurry!

3) The cell phone reads the Personally Descriptive Indicator aloud upon receiving or accessing message.

4) Instead of word indicators, the indicator may be an “emoticon” or other pictorial or diagrammatic indicator.

### Example 3

Applications of the Personally Descriptive Indicator with respect to the operation of Caller ID between two cellular telephones, both of which have the Personally Descriptive Indicator software downloaded:

1) Examples of incoming calls displaying Personally Descriptive Indicator:
Call from . . .
555-555-5555 [Hopeful]
   or
Call from . . .
Dean [Mellow]

2) Missed calls may or may not be subject to update of the Personally Descriptive Indicator. In the case of no update, the Personally Descriptive Indicator remains as it was at the time of the call.

3) Instead of word indicators, the indicator may be an “emoticon” or other pictorial or diagrammatic indicator.

### Example 4

Applications of the Personally Descriptive Indicator with respect to the operation of a list of contacts (“contact list”) between two cellular telephones, both of which have the Personally Descriptive Indicator software downloaded:

1) Examples of contact list names in conjunction with their associated Personally Descriptive Indicators:
Ashley Smith [Inspired]
Brad Brown [Lazy]
Carol Dean [Go getter]
   Each may be preceded by an icon which indicates the phone line source (home, work, cell).

2) People in the contact list who have downloaded the Personally Descriptive Indicator software will have the option of having a Personally Descriptive Indicator associated with their name.

3) Instead of word indicators, the indicator may be an “emoticon” or other pictorial or diagrammatic indicator.

4) The Personally Descriptive Indicator can be updated in real time.

TABLE I
Example Indicators

| | | | |
|---|---|---|---|
| Accomplished | Cranky | Forgotten | Lazy |
| Adored | Crappy | Frisky | Lethargic |
| Adventurous | Crazy | Froggy | Listless |
| Aggravated | Creative | Frustrated | Lonely |
| Amorous | Crunk | Full | Loved |
| Amused | Crushed | Gallant | Luminous |
| Angry | Cultured | Geeky | Mad |
| Animated | Curious | Giddy | Melancholy |
| Annoyed | Cynical | Giggly | Mellow |
| Anxious | Depressed | Gloomy | Mischievous |
| Apathetic | Determined | Good | Miserable |
| Argumentative | Devious | Grateful | Moody |
| Aroused | Dirty | Groggy | Morose |
| Artistic | Disappointed | Grumpy | Naughty |
| Ashamed | Discontent | Guilty | Nauseated |
| Awake | Disgusted | Handsome | Neglected |
| Betrayed | Distractible | Happy | Nerdy |
| Bitchy | Distraught | High | Nervous |
| Blah | Distressed | Hopeful | Ninja |
| Blank | Ditzy | Horny | Nostalgic |
| Blessed | Do or Die | Hot | Numb |
| Blissful | Dorky | Hungover | Obsequious |
| Blitzed | Drained | Hungry | Okay |
| Blustery | Drunk | Hyper | Optimistic |
| Bored | Eccentric | Imaginative | Overstimulated |
| Bouncy | Ecstatic | Impatient | Peaceful |
| Breezy | Electric | Impervious | Peeved |
| Bullied | Embarrassed | Implacable | Pensive |
| Bummed | Energetic | Impressed | Pessimistic |
| Busy | Enlightened | Indescribable | Pirate |
| Calm | Enraged | Indifferent | Pissed off |
| Cantankerous | Enthralled | Indignant | Pissy |
| Catalyzed | Envious | Infuriated | Played |
| Cheerful | Evil | Inquisitive | Pleased |
| Chill | Exanimate | Inspired | Pretty |
| Chipper | Excited | Insubordinate | Prissy |
| Cold | Exhausted | Irate | Productive |
| Complacent | Exotic | Irritated | Pugnacious |
| Confident | Fabulous | Jealous | Pure |
| Confuzzled | Fascinated | Jedi | Quiet |
| Contemplative | Fermented | Jolly | Quixotic |
| Content | Flirty | Jubilant | Rebellious |
| Cooky | Focused | Knighted | Recumbent |
| Refreshed | Scared | Stoked | Uncomfortable |
| Rejected | Selective | Stressed | Understimulated |
| Rejuvenated | Sexy | Strong | Used |
| Relaxed | Shocked | Surprised | Validated |
| Relieved | Sick | Sweaty | Virginal |
| Restless | Silly | Sympathetic | Vital |
| Rockin | Sleepy | Talkative | Voluminous |
| Romantic | Sleezy | Tested | Wanted |
| Rushed | Smart | Thankful | Wacky |
| Ruthless | Smitten | Thirsty | Warm |
| Sad | Sneaky | Thoughtful | Weird |
| Sassy | Sneezy | Tired | Working |
| Satisfied | Sore | Touched | Worried |
| Savage | Stalked | Triumphant | |

What is claimed is:

1. A system comprising:
i) a sending device associated with a sending user, the sending device including an installed operating system/platform and an application; and
ii) a receiving device associated with a receiving user;
wherein the application comprises computer-readable instructions recorded on a computer-readable medium, the instructions comprising instructions to:
1) associate input pictorial, personally descriptive indicator (PDI) corresponding to the sending user with identifying information corresponding to the sending user, thereby creating an associated PDI;
2) transmit the associated PDI to the receiving device, such that the associated PDI can be accessed by the receiving user and displayed by the receiving device; and
3) replace the associated PDI with new PDI to generate a new associated PDI, such that the new associated PDI can be accessed by the receiving user and displayed by the receiving device.

2. A system as in claim 1 wherein the identifying information is a name.

3. A system as in claim 1 wherein the sending device comprises a cellular telephone.

4. A system as in claim 1 wherein the application is downloadable.

5. A system as in claim 1 wherein the operating system/platform comprises the application.

6. A system as in claim 1 wherein the operating system/platform comprises the ANDROID platform.

7. A system as in claim 1 wherein the operating system/platform comprises BLACKBERRY or iOS.

8. A system as in claim 1 wherein the PDI is displayed as an image associated with a name, the name being part of a contact list.

9. A method for transmitting ancillary information from a sending device operated by a sending user to a receiving device operated by a receiving user, said method comprising the steps of:
A) the sending user inputting pictorial, personally descriptive information corresponding to the sender into a sending device, wherein said sending device comprises an operating system/platform and an application; wherein the application imparts to the sending device the ability to:
1) associate input pictorial, personally descriptive information (PDI) corresponding to the sending user with identifying information corresponding to the sending user, thereby creating an associated PDI;
2) transmit the associated PDI to the receiving device, such that the associated PDI can be accessed by the receiving user and displayed by the receiving device; and
3) replace the associated PDI with new PDI to generate a new associated PDI, such that the new associated PDI can be accessed by the receiving user and displayed by the receiving device; wherein the sending device carries out steps 1) and 2); and
B) the receiver accessing the associated PDI and displaying it on the receiving device.

10. A method as in claim 1 wherein the identifying information is a name.

11. A method as in claim 1 wherein the sending device comprises a cellular telephone.

12. A method as in claim 1 wherein the application is downloadable.

13. A method as in claim 1 wherein the operating system/platform comprises the application.

14. A method as in claim 1 wherein the operating system/platform comprises the ANDROID platform.

15. A method as in claim 1 wherein the operating system/platform comprises BLACKBERRY or iOS.

16. A method as in claim 1 wherein the PDI is displayed as an image associated with a name, the name being part of a contact list.
